(19) United States
(12) Patent Application Publication
(10) Pub. No.: US 2017/0078619 A1
(43) Pub. Date: Mar. 16, 2017

(54) METHOD FOR REPORTING RELEVANT DATA OF REPEATER, COMPUTER-READABLE RECORDING MEDIUM USING THE SAME AND ELECTRICAL DEVICE USING THE SAME

(71) Applicant: Coiler Corporation, New Taipei City (TW)

(72) Inventors: Yu-Huei Chang, New Taipei City (TW); HSI-PEN CHANG, New Taipei City (TW); CHIN-LUNG KE, New Taipei City (TW)

(21) Appl. No.: 15/242,936

(22) Filed: Aug. 22, 2016

(30) Foreign Application Priority Data
Sep. 15, 2015 (TW) 104130501

(51) Int. Cl. H04N 7/18; H04N 5/232

(52) U.S. Cl. CPC H04N 7/183; H04N 5/23293; H04L 43/50

(57) ABSTRACT

A method for reporting relevant data of a repeater includes connecting to a repeater; receiving a photographing-enabling signal, performing a connection test for network service related to the repeater according to the photographing-enabling signal, enabling an image-capturing module according to the photographing-enabling signal, simultaneously displaying at least one measured data of the connection test and a scene image imaged by the image-capturing module on a screen, receiving an image-generating signal, and outputting a combined image having the measured data and the scene image according to the image-generating signal.

### CROSS-REFERENCES TO RELATED APPLICATIONS

This non-provisional application claims priority under 35 U.S.C. §119(a) on Patent Application No. 104130501 filed in Taiwan, R.O.C. on Sep. 15, 2015, the entire contents of which are hereby incorporated by reference.

### BACKGROUND

Technical Field

The instant invention relates to a mobile communication system, and more specifically to a method for reporting relevant data of a repeater, a computer-readable recording medium using the same, and an electrical device using the same.

Related Art

In a mobile communication system, a repeater can enhance the coverage range and capacity of the mobile communication system. The repeater is located signally between the base station and the mobile terminal equipment. The repeater is essentially a device for amplifying and transmitting the radiofrequency (RF) signal.

During installation of the repeater, the responsible person needs to perform the parameter setup of the installed repeater. After the setup procedure, the responsible person needs to prepare and send an installation report back to his/her organization (company). However, others cannot assure the genuineness or truth of the installation report.

In addition, as the repeater malfunctions, the responsible person needs to test or debug the repeater on-site. After the test of repeater is finished, the responsible person then sends the testing report back to his/her company by himself/herself. However, others cannot assure if the repeater can provide the expect functionality after the test and debugging.

Therefore, there is a need for a method for reporting the relevant data of the repeater in a convenient and trustworthy way.

### SUMMARY

In an embodiment, a method for reporting relevant data of a repeater includes connecting to the repeater, receiving a photographing-enabling signal, performing a connection test for network service related to the repeater according to the photographing-enabling signal, enabling an image-capturing module according to the photographing-enabling signal, simultaneously displaying at least one measured data of the connection test and a scene image imaged by the image-capturing module on a screen, receiving an image-generating signal, and outputting a combined image having the measured data and the scene image according to the image-generating signal.

In some embodiments, the method further includes linking the combined image with a report file. In still some embodiments, the method further includes inserting the combined image into a report file.

In some embodiments, the method further includes inserting at least one setup parameter of the repeater into a report template to generate the report file.

In some embodiments, the method further includes uploading the combined image to a server. In still some embodiments, the method further includes uploading the report file having the combined image to a server. In still some embodiments, the method further includes: uploading the combined image and the report file to a server.

In some embodiments, in the displaying step, the at least one measured data is overlappingly displayed onto the scene image.

In an embodiment, a computer readable medium includes a program. When the program is loaded and executed by a computer, the program causes the computer to perform the method for reporting relevant data of a repeater of any one of embodiments.

In an embodiment, an electrical device includes a network module, a testing module, an image-capturing module, a screen, a storage unit, and a control unit. The control unit is connected to the network module, the testing module, the image-capturing module, the screen, and the storage unit. The network module is configured to be connected to a repeater. The testing module executes a connection test of the repeater via the network module. The image-capturing module functions to image a scene image. The screen simultaneously displays at least one measured data of the connection test and the scene image. The control unit outputs a combined image having the measured data and the scene image according to an image-generating signal, and the control unit stores the combined image into the storage unit.

In some embodiments, the storage unit further stores a report file, and the control unit links the combined image with the report file. In some embodiments, the report file includes at least one setup parameter of the repeater and an option for hyperlinking to the combined image.

In some embodiments, the storage unit further stores a report file, and the control unit inserts the combined image into the report file. In some embodiments, the report file further includes at least one setup parameter of the repeater.

In some embodiments, the electrical device further includes a setup module connected to the control unit. The setup module outputs, via a parameter setup page, at least one setup parameter of the repeater, and the control unit inserts the setup parameter into a report template to generate a report file.

In some embodiments, the screen displays the measured data overlappingly onto the scene image

In summary, according to the embodiments, the method for reporting relevant data of the repeater, the computer-readable recording medium using the same and the electrical device using the same can applied to test the repeater and combine the test data with the scene image to ensure the genuineness of the testing report.

### BRIEF DESCRIPTION OF THE DRAWINGS

The disclosure will become more fully understood from the detailed description given herein below for illustration only, and thus not limitative of the disclosure, wherein:

FIG. 1 illustrates a flowchart showing a method for reporting relevant data of a repeater according to a first embodiment of the instant disclosure;

FIG. 2 illustrates a flowchart showing a method for reporting relevant data of a repeater according to a second embodiment of the instant disclosure;

FIG. 3 illustrates a functional block diagram of a wireless communication system according to an embodiment of the instant disclosure;

FIG. 4 illustrates an exemplified display image on a screen of FIG. 3;

FIG. 5 illustrates another exemplified display image on the screen of FIG. 3;

FIG. 6 illustrates still another exemplified display image on the screen of FIG. 3;

FIG. 7 illustrates yet still another exemplified display image on the screen of FIG. 3;

FIG. 8 illustrates a flowchart showing a method for reporting relevant data of a repeater according to a third embodiment of the instant disclosure;

FIG. 9 illustrates a flowchart showing a method for reporting relevant data of a repeater according to a fourth embodiment of the instant disclosure;

FIG. 10 illustrates a flowchart showing a method for reporting relevant data of a repeater according to a fifth embodiment of the instant disclosure;

FIG. 11 illustrates a flowchart showing a method for repeating relevant data of a reporter according to seventh to twelfth embodiments of the instant disclosure;

FIG. 12 illustrates a functional block diagram of a wireless communication system according to another embodiment of the instant disclosure;

FIG. 13 illustrates a flowchart showing a method for repeating relevant data of a reporter according to thirteenth to eighteenth embodiments of the instant disclosure;

FIG. 14 illustrates a functional block diagram of a wireless communication system according to still another embodiment of the instant disclosure;

FIG. 15 illustrates a flowchart showing a method for repeating relevant data of a reporter according to nineteenth to twenty fourth embodiments of the instant disclosure;

FIG. 16 illustrates a schematic diagram showing a parameter setup page according to an embodiment of the instant disclosure;

FIG. 17 illustrates a schematic diagram showing a parameter setup page according to another embodiment of the instant disclosure; and

FIG. 18 illustrates a schematic diagram showing a parameter setup page according to still another embodiment of the instant disclosure.

### DETAILED DESCRIPTION

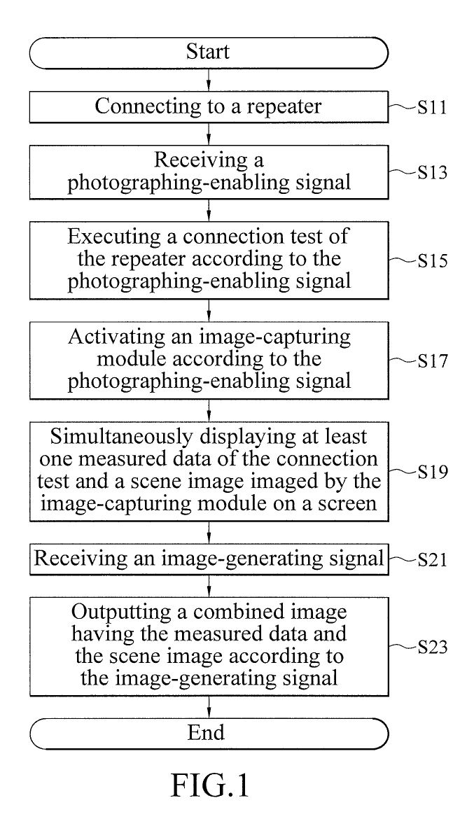

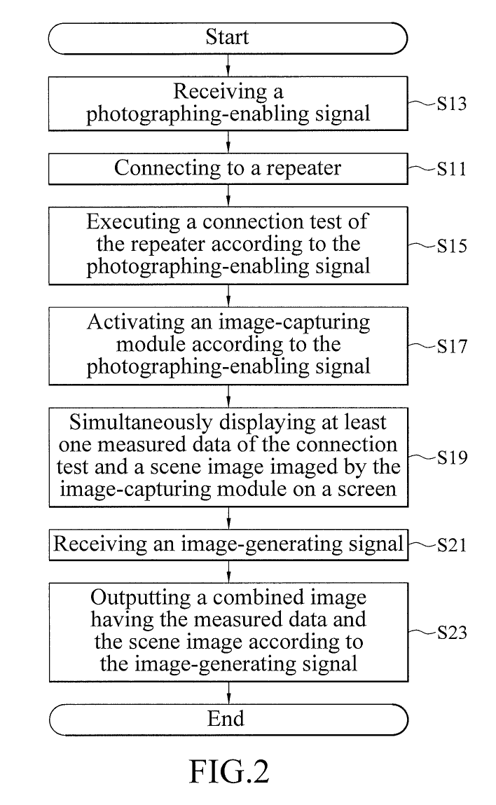

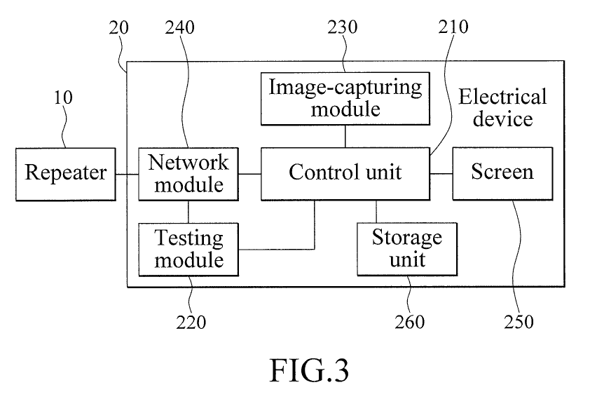

FIG. 1 illustrates a flowchart of a method for reporting relevant data of a repeater according to a first embodiment of the instant invention. FIG. 2 illustrates a flowchart of a method for reporting the relevant data of a repeater according to a second embodiment of the instant invention. FIG. 3 illustrates a functional block diagram of a wireless communication system according to an embodiment of the instant invention.

Referring to FIGS. 1 to 3, the wireless communication system includes a repeater 10 and an electrical device 20, wherein the electrical device 20 is capable of testing the repeater 10.

In some embodiments, the method for reporting the relevant data of the repeater according to any embodiment is realized by a computer program product including a program. As the computer (i.e., the electrical device 20) loads and executes the program, the program can cause the computer to perform the method for reporting the relevant data of the repeater of any embodiment. In some embodiments, the computer program product is a readable record medium, and the program is stored in the record readable medium for being loaded by the electrical device 20. In some embodiments, the program per se (i.e., the program itself) is the computer program product, and the program is transmitted to the electrical device 20 wirelessly or wiredly.

The electrical device 20 includes a control unit 210, a testing module 220, an image-capturing module 230, a network module 240, a user-interface, and a storage unit 260. In some embodiments, the user-interface is a touch-control screen, a combination of a typical screen and multiple physical buttons, or a combination of a touch-control screen and multiple physical buttons. The multiple physical buttons can be implemented by a keyboard, a mouse, or combination thereof. For the sake of convenience, in the followings, a touch-control screen 250 is used as an example of the user-interface. The control unit 210 is connected to the testing module 220, the image-capturing module 230, the network module 240, the screen 250 (the user-interface), and the storage unit 260.

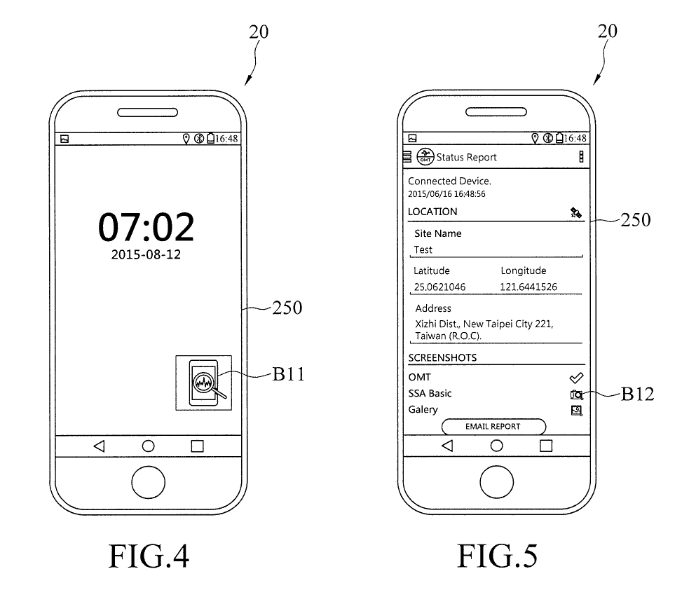

In some embodiments, the above-mentioned program is an App (software application). The control unit 210 executes the installation procedure of the App, stores the App in the storage unit 260, and displays the icon B11 corresponding to the App on the screen 250, as shown in FIG. 4.

In some embodiments, as the icon B11 is tapped (clicked), the control unit 210 executes the App to provide a photographing-enabling button B12 on the screen 250, as shown in FIG. 5.

As the photographing-enabling button B12 is tapped, the photographing-enabling button B12 generates a photographing-enabling signal. At this time, the control unit 210 receives the photographing-enabling signal representing the photographing-enabling button B12 being tapped (step S13).

In some embodiments, as the icon B11 is tapped, the control unit 210 executes the App and receives the photographing-enabling signal through the execution of the App (step S13).

In some embodiments, the control unit 210 connects to the repeater 10 via the network module 240 by the execution of the App (step S11), as shown in FIG. 1. In some embodiments, the control unit 210 might, in response to the photographing-enabling signal, connects to the repeater 10 via the network module 240 (step S11), as shown in FIG. 2. Wherein, the network module 240 connects to the repeater 10 wiredly or wirelessly. For instance, the control unit 210, via the network module 240, builds up a data communication connection with the repeater 10. Alternatively, the control unit 210, via the network module 240 along with the repeater 10, builds up a data communication connection with other devices (e.g., server(s)). In a further option, the control unit 210, via the network module 240, receives amplified and transmitted signal sent by the repeater 10.

In some embodiments, the control unit 210, through the execution of the App, provides a connection test procedure. In other words, the control unit 210 performs the connection test procedure regarding to a network communication supported by the repeater 10. In some embodiments, the connection test includes, but not limited, the connection test of control parameters of the repeater 10, the connection test of the network communication of the electrical device 20 within the network service range of the repeater 10, the connection test between the electrical device 20 and surrounding signals within the network service range of the repeater 10, or any of the combinations thereof.

Within the coverage range supported by the repeater 10, the control unit 210, according to the photographing-enabling signal, activates the testing module 220 to execute a connection test of related network service of the repeater 10 according to the connection test procedure. In other words, the testing module 220, according to the photographing-enabling signal, executes a connection test of the repeater 10 (step S15).

In addition, the control unit 210, according to the photographing-enabling signal, activates the image-capturing module 230 (step S17).

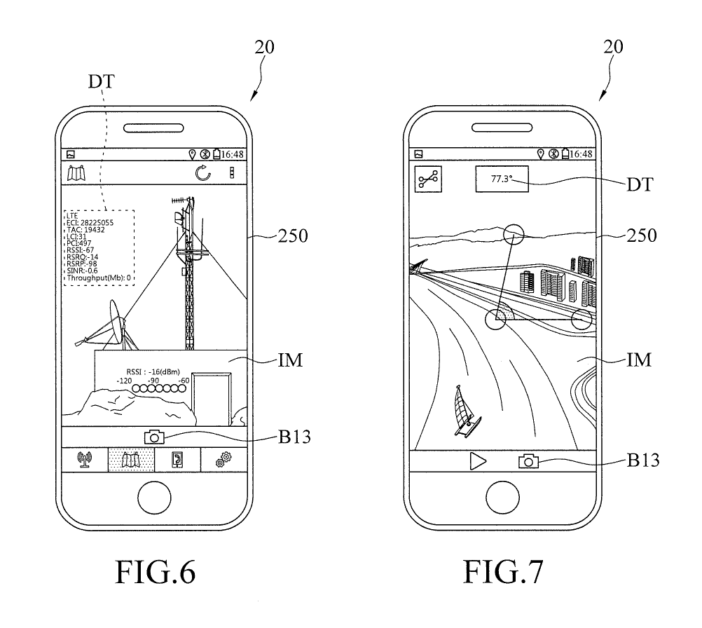

After the activation of the image-capturing module 230, the control unit 210 commands the screen 250 to simultaneously display at least one measured data DT of the connection test of related network service of the repeater 10 and a scene image IM imaged by the image-capturing module 230 (step S19), as shown in FIG. 6. In this embodiment, the measured data DT of the connection test and the scene image IM can be displayed on the screen 250 instantly. As a result, the measured data DT of connection test of related network service of the repeater 10 and the scene image IM imaged by the image-capturing module 230 are displayed on the screen 250 can be provided for the preview by a user.

In some embodiments, the screen 250 displays the measured data DT onto the scene image IM overlappingly, as shown in FIG. 6.

In some embodiments, as shown in FIG. 7, the screen 250 displays the scene image IM and the measured data DT in a picture in picture manner. Wherein, the main window displays the scene image IM and the inserted window displays the measured data DT.

In some embodiments, the communication network may be CDMA (Code Division Multiple Access), GSM (Global System for Mobile Communications), WCDMA (Wideband Code Division Multiple Access), HSUPA (High Speed Uplink Packet Access), HSDPA (High-Speed Downlink Packet Access), WiMax (Worldwide Interoperability for Microwave Access), LTE (Long Term Evolution), 3GPP LTE (3rd Generation Partnership Project LTE), UMB (Ultra Mobile Broadband) or LTE-A (LTE Advanced).

In some embodiments, the measured data might be Cell ID, RX (GSM RX-level, 2G signal strength), LAC (Location Area Code), MCC (Mobile Country Code), MNC (Mobile Network Code), RS SI (Received Signal Strength Indication), RSCP (Received Signal Code Power), ado (Effect Energy/Total Energy and Noise), PSC (Primary Scrambling Code), RNC (Radio Network Controller), RSRQ (Reference Signal Receiving Quality), RSRP (Reference Signal Receiving Power), SINR (Signal to Interference plus Noise Ratio), ECI (E-UTRAN Cell Identifier), eNBID (eNodeB Identifier), LCI (Logical Channel Identity), PCI (Physical Layer Cell Identity), TAC (Tracking Area Code), Throughput, measurement angle or any combinations thereof.

In some embodiments, the measured data are displayed on the screen 250 immediately. In other words, the measured data shown by the screen 250 are the measured data in real time as App is executed.

As the preview picture (i.e., the measured data and the scene image) is displayed on the screen 250, the control unit 210 at the same time provides an image retrieval button B13 on the screen 250, as shown in FIG. 6.

As the image retrieval button B13 is tapped, the control unit 210 receives an image-generating signal representing the image retrieval button B13 is tapped (step S21). Next, according to the image-generating signal, the control unit 210 outputs the combined image having the measured data and the scene image (step S23). For instance, the control unit 210, in response to the image retrieval button B13, combines the measured data and scene image to produce the combined image and stores the combined image into the storage unit 260. In other words, the control unit 210 generates a combined image identical to the preview picture shown on the screen 250 and stores the combined image into the storage unit 260. As a result, the user can send the combined image as a testing report back to his/her organization (company).

In some embodiments, the storage unit 260 stores a report template.

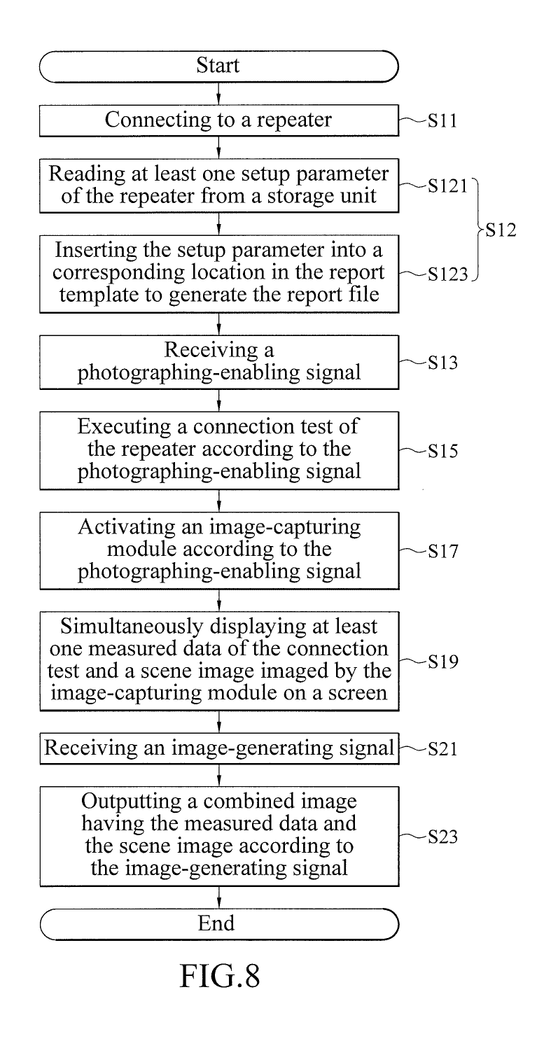

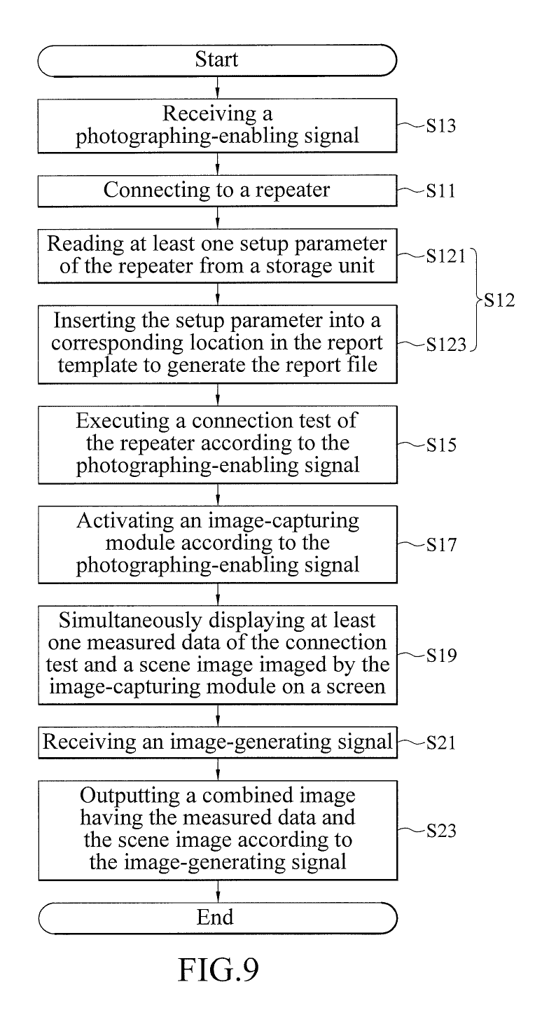

In some embodiments, referring to FIG. 8 and FIG. 9, within the range covered and supported by the repeater 10, the control unit 210 reads the report template and at least one setup parameter of the repeater 10 from the storage unit 260 (step S121). Then, the control unit 210 inserts the setup parameter into a corresponding location in the report template to generate a report file (step S123). Next, the control unit 210 stores the generated report file into the storage unit 260. In this embodiment, the photographing-enabling button B12 can have an option (e.g., text or icon) for hyperlinking to a photography function, as shown in FIG. 5.

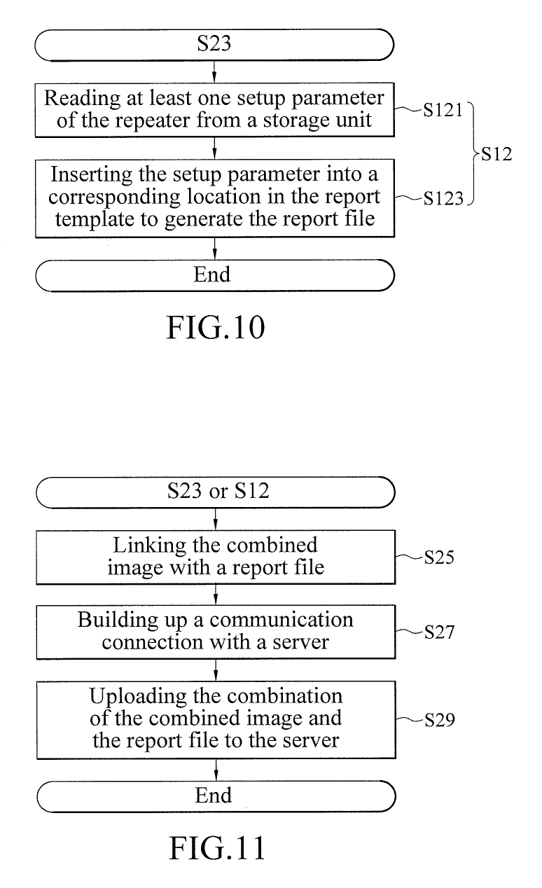

In some embodiments, referring to FIG. 10, as the combined image is generated, the control unit 210 generates the report file (step S12). The way of the generation of the report file is same as previously mentioned. In this embodiment, the photographing-enabling button B12 may be a function button of the App.

In some embodiments, referring to FIG. 11, after the control unit 210 generates the combined image, the control unit 210 links the combined image with the report file (step S25). In other words, the report file has text or icon for hyperlinking to the combined image. Therefore, the user can send the combination of the report file and the combined image, as the testing report, back to his or her organization (company).

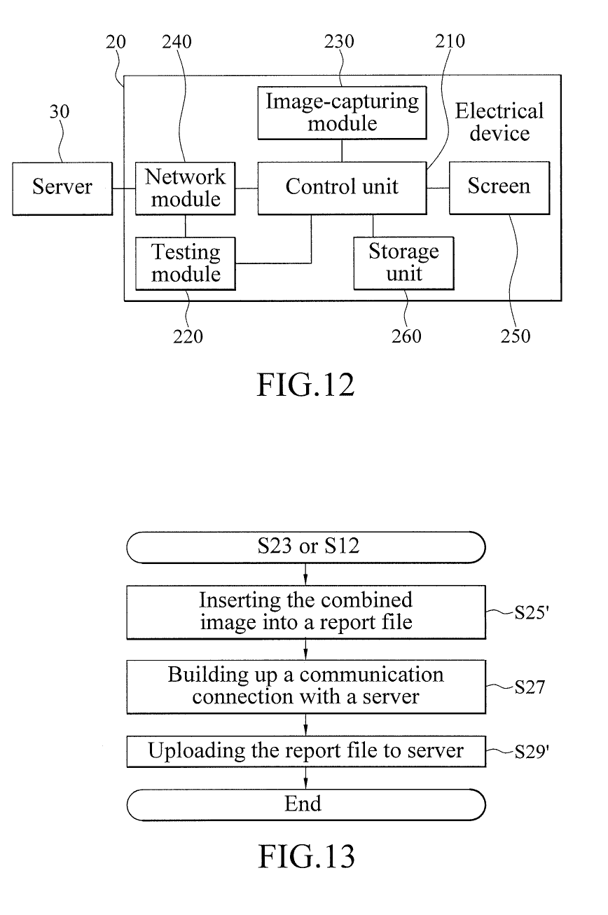

In some embodiments, referring to FIGS. 11 and 12, the control unit 210 builds up a communication connection with a server 30 via the network module 240 (step S27). Then, the control unit 210, via the network module 240, uploads the combination of the combined image and the report file to the server 30 (step S29).

In some embodiments, referring to FIG. 12, as the control unit 210 generates the combined image, the control unit 210 inserts the generated combined image into the report file (step S25′). In other words, the report file has the combined image. As such, the user can directly send the report file back to his company.

In some embodiments, referring to FIGS. 12 and 13, after the control unit 210, via the network module 240, builds up the communication connection with the server 30 (step S27), the control unit 210, via the network module 240, uploads the report file having the combined image to the server 30 (step S29′).

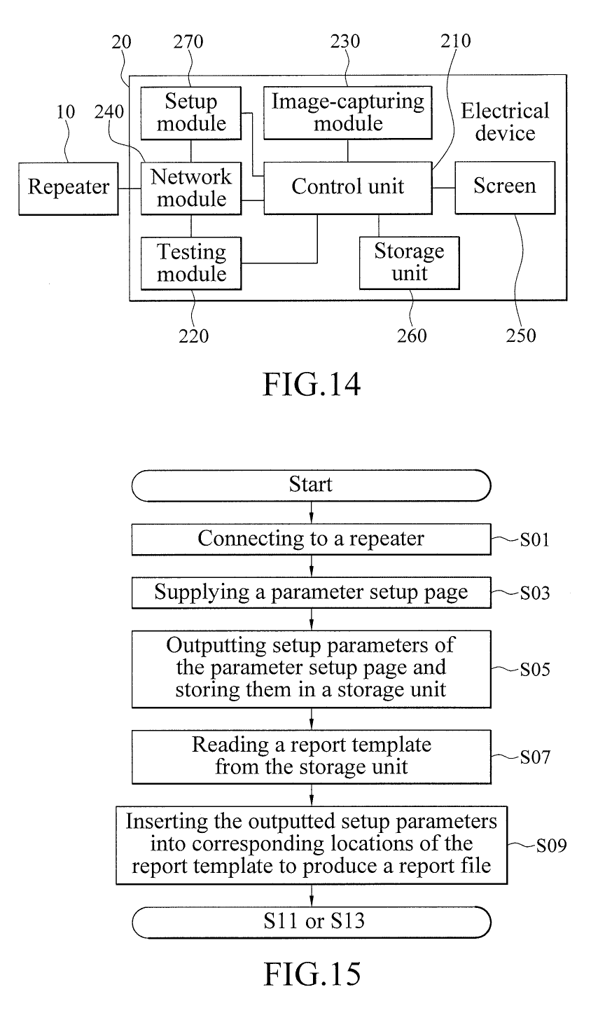

In some embodiments, in addition to the connection test procedure, the App also has a parameter setup procedure executed by the control unit 210. Referring to FIG. 14, the electrical device 20 may further include a setup module 270 connected to the control unit 210.

In some embodiments, after the control unit 210 executes the App, the control unit 210 provides a monitoring option. Referring to FIG. 15, as the monitoring option is enabled, by the execution of App and via the network module 240, the control unit 21 connects to the repeater 10 (step S01) and enables the setup module 270. The setup module 270 supplies a parameter setup page (step S03) according to the parameter setup procedure, allowing the user to perform the relevant parameter setup of the connected repeater 10.

In some embodiments, the parameter setup page may have items of controls, monitor, alarms, or any of the combinations thereof.

In some embodiments, the repeater 10 may be a fiber repeater, an interference cancellation system (ICS) repeater, or variable band repeater.

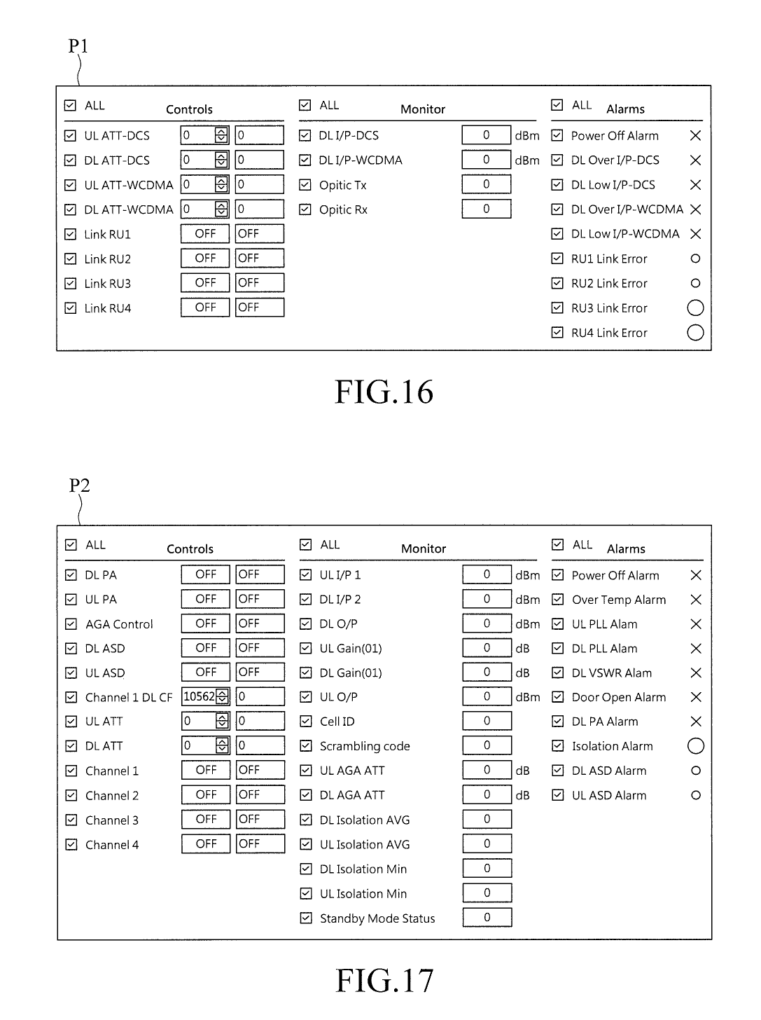

For instance of the fiber repeater, the setup module 270 provides the parameter setup page P1 as shown in FIG. 16. In the parameter setup page P1 for the fiber repeater, the items of Controls may have UL ATT-DCS (Up Link Attenuation-Digital Cellular System), DL ATT-DCS (Down Link Attenuation-Digital Cellular System), UL ATT-WCDMA (Up Link Attenuation-Wideband Code Division Multiple Access), DL ATT-WCDMA (Down Link Attenuation-Wideband Code Division Multiple Access), Link RU1 (Link Remote Unit 1), Link RU2 (Link Remote Unit 2), Link RU3 (Link Remote Unit 3), Link RU4 (Link Remote Unit 4), or any of the combinations thereof. In parameter setup page P1 for the fiber repeater, the items of Monitor may have DL I/P-DCS (Down Link Input Power-Digital Cellular System), DL I/P-WCDMA (Down Link Input Power-Wideband Code Division Multiple Access), Optic Tx/Rx (fiber transmission/reception), or any of the combinations thereof. In the parameter setup page P1 for the fiber repeater, the items of Alarms may have Power Off Alarm, DL Over I/P-DCS (Down Link Input Power Over Alarm-Digital Cellular System), DL Low I/P-DCS (Down Link Input Power Low Alarm-Digital Cellular System), DL Over I/P-WCDMA (Down Link Input Power Over Alarm-Wideband Code Division Multiple Access), DL Low I/P-WCDMA (Down Link Input Power Low Alarm-Wideband Code Division Multiple Access), RU1 Link Error (Remote Unit 1 Link Error Alarm), RU2 Link Error (Remote Unit 2 Link Error Alarm), RU3 Link Error (Remote Unit 3 Link Error Alarm), RU4 Link Error (Remote Unit 4 Link Error Alarm), or any of the combinations thereof.

For instance of the ICS repeater, the setup module 270 provides the parameter setup page P2 as shown in FIG. 17. In the parameter setup page P2 for the ICS repeater, the items of Controls may have DL PA (Down Link Power Amplifier), UL PA (Up Link Power Amplifier), AGA control (Auto Gain Adjust Control), DL ASD (Down Link Auto Shutdown), UL ASD (UP Link Auto Shutdown), Channel 1 DL CF (Channel 1 Down Link Center Frequency), UL ATT (Up Link attenuation), DL ATT (Down Link attenuation), Channel 1 (channel 1 On or Off), Channel 2 (channel 2 On or Off), Channel 3 (channel 3 On or Off), Channel 4 (channel 4 On or Off), or any of the combinations thereof. In the parameter setup page P2 for the ICS repeater, the items of Monitor may have UL I/P 1 (channel 1 Up Link Input Power), DL I/P 1 (channel 1 Down Link Input Power), DL O/P (Down Link Output Power), UL Gain (01) (channel 1 Up Link Gain), DL Gain (01) (channel 1 Down Link Gain), UL O/P (Up Link Output Power), Cell ID, Scrambling Code, UL AGA ATT (Up Link Auto Gain Adjust Control attenuation), DL AGA ATT (Down Link Auto Gain Adjust Control attenuation), DL Isolation AVG (Down Link Isolation AVG), UL Isolation AVG (Up Link Isolation AVG), DL Isolation Min (Down Link Isolation Min), UL Isolation Min (Up Link Isolation Min), Standby Mode Status, or any of the combinations thereof. In the parameter setup page P2 for the ICS repeater, the items of Alarms may have Power Off Alarm, Over Temp Alarm, UL PLL Alarm (UP Link Phase Loop Lock Alarm), DL PLL Alarm (Down Link Phase Loop Lock Alarm), DL VSWR Alarm (Down Link Voltage Standing Wave Ratio Alarm), Door Open Alarm, DL PA Alarm (Down Link Power Amplifier Error Alarm), Isolation Alarm, DL ASD Alarm (Down Link Auto Shutdown Alarm), UL ASD Alarm (Up Link Auto Shutdown Alarm) or any of the combinations thereof.

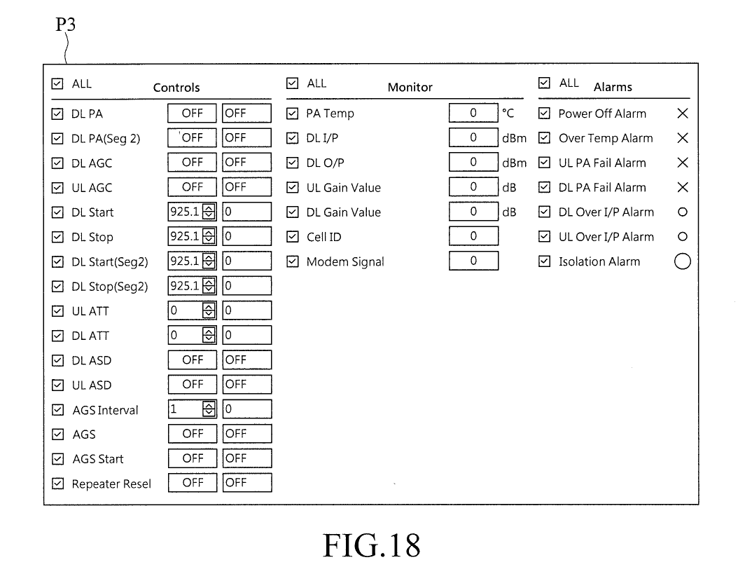

For instance of the variable band repeater, the setup module 270 provides the parameter setup page P3 as shown in FIG. 18. In the parameter setup page P3, the items of Controls may have DL PA (Down Link Power Amplifier), DL PA (Seg 2) (Down Link Power Amplifier (Seg 2)), DL AGC (Down Link Auto Gain Control), UL AGC (Up Link Auto Gain Control), DL Start (Down Link Start Frequency), DL Stop (Down Link Stop Frequency)), DL Start (Seg 2) (Down Link Start Frequency (Seg 2)), DL Stop (Seg 2) (Down Link Stop Frequency (Seg 2)), UL ATT (Up Link attenuation), DL ATT (Down Link attenuation), DL ASD (Down Link Auto Shutdown On or Off), UL ASD (Up Link Auto Shutdown On or Off), AGS Interval (Auto Gain Set Interval), AGS (Auto Gain Setup), AGS Start (Auto Gain Setup Start), Repeater Reset, or any of the combinations thereof. In the parameter setup page P3, the items of Monitor may have PA Temp (Power Amplifier Temperature), DL I/P (Up Link Input Power), DL O/P (Up Link Output Power), UL Gain (Up Link Gain), DL Gain (Down Link Gain), Cell ID, Modem Signal, or any of the combinations thereof. In the parameter setup page P3, the items of Alarms may have Power Off Alarm, Over Temp Alarm, UL PA Fail Alarm (Up Link Power Amplifier Fail Alarm), DL PA Fail Alarm (Down Link Power Amplifier Fail Alarm), DL Over I/P Alarm (Down Link Input Power Over Alarm), UL Over I/P Alarm (Up Link Input Power Over Alarm), Isolation Alarm, or any of the combinations thereof.

After the items in the parameter setup page have been set up, the setup module 270 outputs the setup parameters of the parameter setup page and stores them in the storage unit 260 (step S05).

In some embodiments, as the parameter setup page has multiple setup items, the setup module 270 can provide the setup items in sequence according to the different setup pages. In other words, the parameter setup page includes multiple sub-setup pages.

Taking the situation of the parameter setup page having Controls, Monitor and Alarms parameters as an example, the setup module 270 may provide the sub-setup pages of items of Controls firstly. After the setup of items of Controls have been completed (i.e., the option box in sub-setup pages of items of Controls has been ticked), the setup module 270 provides the sub-setup pages of items of Monitor. After the setup of items of Monitor have been completed (i.e., the option box in sub-setup pages of items of Monitor has been ticked), the setup module 270 provides the sub-setup pages of items of Alarms. After the setup of items of Alarm have been completed (i.e., the option box in sub-setup pages of items of Alarms has been ticked), the setup module 270 outputs all setup parameters ticked and stores them in the storage unit 260.

In some embodiments, as the setup parameters are outputted, the control unit 210 reads the report template from the storage unit 260 (step S07) and inserts the outputted setup parameters into corresponding locations of the report template to generate a report file (step S09). Then, the control unit 210 stores the generated report file to the storage unit 260. In other words, before the testing module 22 executes the connection test of network service related to the repeater 10, the control unit 210 already generates the report file and stores it in the storage unit 260.

In some embodiments, as the user intends to execute the connection test of network service related to the repeater 10, the control unit 210 reads the report file from the storage unit 260, and provides a photographing-enabling button B12, as shown in FIG. 5, through the report file.

In some embodiments, in addition to simultaneously showing the measured data DT and scene image IM, the screen 250 also displays the device data of the electrical device 20 (not shown) along with the measured data DT and the scene image IM at the same time. Under this scenario, the generated combined image includes the measured data DT, the device data, and the scene image IM. In addition, the measured data DT and the device data are laid over the scene image IM. The device data may be, but not limited to, device name, time, etc.

In some embodiments, the electrical device 20 may be, for instance, smart phone, Personal Navigation Device (PND), Digital Photo Frame (DPF), e-book, notebook, Tablet or Pad, or other hand-held devices.

In some embodiments, the functions of control unit 210 and the testing module 220 (and the setup module 270) can be realized by one or more processor units.

In some embodiments, the processor unit may be a microprocessor, a microcontroller, a digital signal processor, a micro-computer, a central processor unit, a Field Programmable Gate Array, a programmable logic device, a state machine, a logical circuitry, an analog circuit, a digital circuit, and/or any devices capable of manipulating signals (digital and/or analog) based on operating instructions.

In some embodiments, the storage unit may be ROM, RAM, Volatile Memory, Non-volatile Memory, SRAM, DRAM, Flash RAM, and/or any device capable of storing digital information.

In summary, according the embodiments, the method for reporting relevant data of the repeater, the computer-readable recording medium using the same, and the electrical device using the same can be applied to test the repeater and combine the test data with the scene image to ensure the truth of the testing report.

What is claimed is:

1. A method for reporting relevant data of a repeater, comprising:
connecting to the repeater;
receiving a photographing-enabling signal;
performing a connection test for network service related to the repeater according to the photographing-enabling signal;
enabling an image-capturing module according to the photographing-enabling signal;
simultaneously displaying at least one measured data of the connection test and a scene image imaged by the image-capturing module on a screen;
receiving an image-generating signal; and
outputting a combined image having the measured data and the scene image according to the image-generating signal.

2. The method for reporting relevant data of a repeater of claim 1, further comprising:
linking the combined image with a report file.

3. The method of claim 2, further comprising:
inserting at least one setup parameter of the repeater into a report template to generate the report file.

4. The method for reporting relevant data of a repeater of claim 2, further comprising:
uploading the combined image and the report file to a server.

5. The method for reporting relevant data of a repeater of claim 1, further comprising:
inserting the combined image into a report file.

6. The method for reporting relevant data of a repeater of claim 5, further comprising:
inserting at least one setup parameter of the repeater into the report file.

7. The method for reporting relevant data of a repeater of claim 5, further comprising:
uploading the report file to a server.

8. The method for reporting relevant data of a repeater of claim 1, further comprising:
inserting at least one setup parameter of the repeater into a report template to generate the report file.

9. The method for reporting relevant data of a repeater of claim 8, further comprising:
uploading the combined image and the report file to a server.

10. The method for reporting relevant data of a repeater of claim 1, further comprising:
uploading the combined image to a server.

11. The method for reporting relevant data of a repeater of claim 1, wherein in the displaying step, the measured data is overlappingly displayed onto the scene image.

12. A computer readable medium, comprising a program, wherein when the program is loaded and executed by a computer, the program causes the computer to perform the method for reporting relevant data of a repeater of claim 1.

13. An electrical device, comprising:
a network module, for being connected to a repeater;
a testing module, for performing a connection test for network service related to the repeater via the network module;
an image-capturing module, for imaging a scene image;
a screen, for simultaneously displaying at least one measured data of the connection test and the scene image;
a storage unit; and
a control unit, connected to the network module, the testing module, the image-capturing module, the screen, and the storage unit, wherein the control unit is for outputting a combined image having the measured data and the scene image according to an image-generating signal and storing the combined image into the storage unit.

14. The electrical device of claim 13, wherein the storage unit further stores a report file, and the control unit links the combined image with the report file.

15. The electrical device of claim 14, wherein the report file comprises at least one setup parameter of the repeater and an option for hyperlinking to the combined image.

16. The electrical device of claim 13, wherein the storage unit further stores a report file, and the control unit inserts the combined image into the report file.

17. The electrical device of claim 16, wherein the report file further comprises at least one setup parameter of the repeater.

18. The electrical device of claim 13, further comprising: a setup module, connected to the control unit, wherein the setup module is for outputting at least one setup parameter of the repeater via a parameter setup page, wherein the control unit inserts the setup parameter into a report template to generate a report file.

19. The electrical device of claim 13, wherein the screen displays the measured data overlappingly onto the scene image.
